(19) United States
(12) Patent Application Publication
(10) Pub. No.: US 2001/0046074 A1
(43) Pub. Date: Nov. 29, 2001

(54) Protection switching apparatus for 1 + 1 optical transmission lines

(76) Inventors: Sunao Kakizaki, Kawasaki (JP); Hideaki Tsushima, Komae (JP); Takashi Mori, Yokohama (JP); Masahiro Takatori, Yokohama (JP); Yukio Hayashi, Fujisawa (JP); Shinichi Kuwano, Yokohama (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 09/848,916

(22) Filed: May 4, 2001

(30) Foreign Application Priority Data
May 25, 2000 (JP) 2000-155267

(51) Int. Cl. H04B 10/08; H04B 10/12

(52) U.S. Cl. 359/110; 359/173

(57) ABSTRACT

Upon receiving a check request 300 from a management system 250, a controller 230 sends a switching request 310 to an optical switch driver 165. The optical switch driver 165 sends a drive signal 320, and an optical switch 160 switches from a first transmission line 120 to a second transmission line 130. A receive signal performance monitor 190 sends a sensing result 330 for the second transmission line 130 to the controller 230. The controller 230 sends a switch-back request 340, and the optical switch 160 switches from the second transmission line 130 to the first transmission line 120. Based on information from the receive signal performance monitor 190, a first transmission line optical sensor 210, and a second transmission line optical sensor 220, the controller 230 performs a sensing result save 360 in a memory 240. A management system 250 saves a results report 400 from the controller 230 in a memory device.

### BACKGROUND OF THE INVENTION

The present invention relates to a protection switching apparatus for 1+1 optical transmission lines for the switching of ‘working’ and ‘protection’ circuits in an optical communication system, and in particular to an optical 1+1 switching apparatus with protection circuit monitoring capability.

First, a conventional configuration for a 1+1 switching function will be described as disclosed in Japanese Patent Kokai (pre-grant publication) No. H6-244796 and Tong-Ho Wu, “Fiber Network Service Survivability,” Artech House (1992) pp.88-93. FIG. 1 shows a block diagram of a conventional electrical 1+1 switching configuration. This electrical 1+1 switching configuration comprises an electrical signal divider 901, a working circuit optical signal transmitter or operational optical transmission unit 903, a protection circuit optical signal transmitter 905, a working circuit optical fiber 907, a protection circuit optical fiber 909, a working circuit optical signal receiver or operational optical reception unit 911, a protection circuit optical signal receiver or protection optical reception unit 913, a working circuit performance monitor or operational performance monitor unit 915, a protection circuit performance monitor 917, and an electrical switch 919. At the transmission end, the transmission data is split by the electrical signal divider 901 and the divided signal is outputted to the working and protection circuit optical signal transmitters 903 and 905 which in turn output optical signals to the working and protection circuit optical fibers 907 and 909. At the reception end, the optical signals are received and converted to electrical signals by the working and protection circuit optical signal receivers 911 and 913. These electrical signals are then respectively outputted to the working and protection circuit performance monitors 915 and 917 which monitor the performance parameters listed in FIG. 13. The electrical switch 919 then selects a good signal based on monitor data that include loss/degradation of output signal, loss of frame sync, alarm indication signal (AIS) from the performance monitors.

FIG. 2 shows a block diagram illustrating a conventional optical 1+1 switching configuration. This optical 1+1 switching configuration comprises an optical signal transmitter or optical transmission unit 1001, an optical divider 1002, a working circuit optical fiber 1003, a protection circuit optical fiber 1004, an optical switch 1005, an optical signal receiver or optical reception unit 1006, optical sensors or optical detection units 1007 and 1008, and an optical switch controller 1009. At the transmission end, an optical signal output by the optical signal transmitter 1001 is divided by the optical coupler 1002 and outputted to the working and protection circuit optical fibers 1003 and 1004. At the reception end, the optical switch selects either the working circuit optical fiber 1003 or the protect circuit optical fiber 1004 so that the selected fiber is connected to the optical signal receiver 1006. Optical sensors 1007 and 1008 monitor the optical signal strength of the signals, and provide the monitored data as indicated in FIG. 3. Based on this monitored data (degraded optical signal strength), the optical switch controller 1009 controls the optical switch 1005 to select a good signal.

The equipment in the conventional electrical 1+1 switching configuration is completely redundant but the redundancy made it expensive. In the conventional optical 1+1 switching scheme, the optical transmitter and receiver did not necessarily have to be redundant, and the cost is less expensive. Although it was less expensive, this system did not provide the required switching performance since it is only based on the optical signal strength. As used here, the term, ‘switching performance’ refers to performance in terms of switching to maintain transmitted signal quality: i.e., quickly switching to a protection circuit when an equipment failure occurs in the working circuit, and quickly restoring normal operation after switching.

Japanese Patent Kokai No. H8-125636 and H11-331043 disclose prior art information that is related to the present application.

It is an object of the present invention to provide a capability to obtain information from both an optical sensor that is capable of monitoring the reduced optical signal strength and a received signal performance monitor that is capable of monitoring received signal performance, in order to provide the required switching performance.

### SUMMARY OF THE INVENTION

As a means of accomplishing the above objectives, the present invention includes, in a protection switching apparatus for 1+1 optical transmission lines, a first and a second optical sensors provided respectively in a first and second transmission lines; an optical switch for selecting, by means of a controller, the signal of one or the other of the first and second transmission lines; and a performance monitor for monitoring performance with respect to the signal selected by the optical switch.

Also, in order to ensure that there will be positive signal continuity after switching, before switching, said controller transmits a switch request followed by a switch-back request, to the optical switch, to monitor the protection circuit for a prescribed minimum time before switching.

In addition, checks are performed to determine whether the transmission line that became the protection circuit after the switch-over, has once again become operational (through actions to restore service, etc.). That is, when a fault condition occurs, the optical switch switches traffic to the protection circuit based on a request from the controller. In addition, after a prescribed amount of time, the controller monitors the transmission line that has just become the protection circuit, and after monitoring sends a switch request to the optical switch to switch traffic back to the original circuit. Thus, after the working and protection circuits are switched, the protection circuit is monitored for a prescribed amount of time.

As another means of accomplishing the stated objective of the present invention, in a protection switching apparatus for 1+1 optical transmission lines, a first and a second transmission lines respectively are provided with a first and a second transmission line output unit for monitoring optical signal performance. An optical switch selects by means of a controller the signal of one or the other of the transmission lines. A first and a second optical sensors separately monitor optical signals respectively transmitted over the first and the second transmission lines so that switching is performed based on information obtained from the first and second transmission line output units and the first and second optical sensors.

As yet another means of accomplishing the stated objective of the present invention, in a protection switching apparatus for 1+1 optical transmission lines, a first and a second transmission line output unit, and a first and a second optical sensor are provided for performing respectively performance monitoring and optical signal strength monitoring for optical signals transmitted over a first and a second transmission lines. Also blocking devices for blocking optical signal outputs from each of the transmission line output devices, and an optical switch are provided for selecting, by means of a controller, the signal of one or the other of the respective transmission lines. In this configuration, optical signal outputs are blocked based on performance monitoring results that are obtained from the two transmission line output units, and switching is performed based on information from the first and second optical sensors.

As another means of accomplishing the stated objective of the present invention, in a protection switching apparatus for 1+1 optical transmission lines, a first and a second transmission line output unit and a first and a second optical sensor are provided for performing performance monitoring and optical signal strength monitoring of optical signals transmitted over a first and a second transmission lines. A blocking device for blocking, by means of a controller, the optical signal outputs from the first and second transmission line output units, and an optical combiner for combining optical signals are additionally provided. In this configuration, optical signal outputs are blocked and combined by the lightwave mixer based on performance monitoring results that are obtained from the two transmission line output devices as well as based on information from the first and second optical sensors.

### BRIEF DESCRIPTION OF THE DRAWINGS

Preferred embodiments of the present invention will now be described with reference to the accompanying drawings, in which:

FIG. 1 is a block diagram illustrating a conventional electrical 1+1 switching configuration.

FIG. 2 is a block diagram illustrating a conventional optical 1+1 switching configuration.

FIG. 3 is a table showing the parameters monitored by optical sensors and performance monitors.

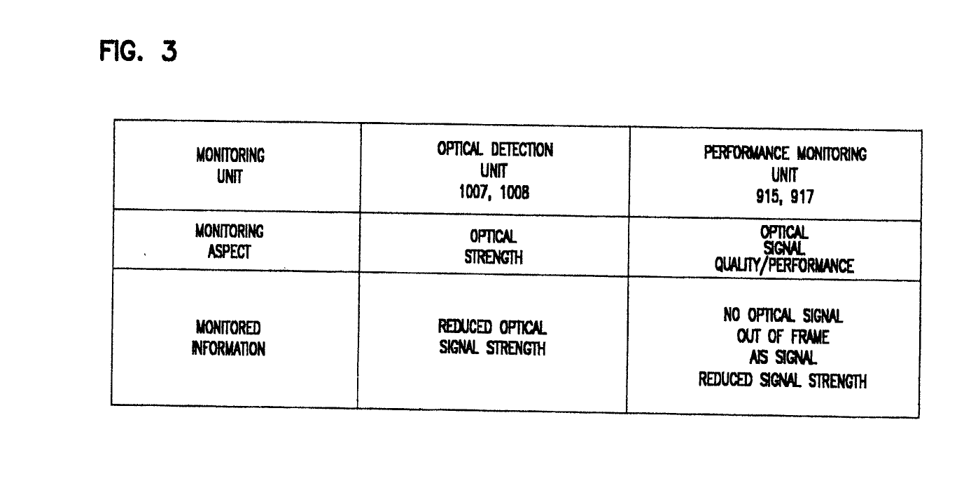

FIG. 4 is a block diagram illustrating a basic optical 1+1 switching configuration.

FIG. 5 shows a pre-switching check sequence for monitoring pursuant to switching between the working and protection circuits.

FIG. 6 shows a post-switching check sequence for monitoring pursuant to switching between the working and protection circuits.

FIG. 7 shows a check sequence for periodic monitoring of a protection circuit.

FIG. 8 shows a configuration for a package provided with first exemplary monitor ports.

FIG. 9 shows a configuration for a package provided with exemplary second monitor ports.

FIG. 10 shows a configuration for a package provided with third exemplary monitor ports.

FIG. 11 shows an example of an alternative monitor port.

FIG. 12 is a block diagram illustrating a system with a function for indicating the path selection state at the transmission end.

FIG. 13 shows the configuration of a transmit-end package front panel.

FIG. 14 is a block diagram for a 1+1 optical switching scheme in which switching is based on performance monitor information obtained from a transmission line output unit.

FIG. 15 is a block diagram for a basic 1+1 optical switching configuration in which switching is performed by blocking the optical output signal of a transmission line output unit.

FIG. 16 is a block diagram for a basic optical 1+1 switching configuration in which no optical switch is used.

### DESCRIPTION OF THE PREFERRED EMBODIMENTS

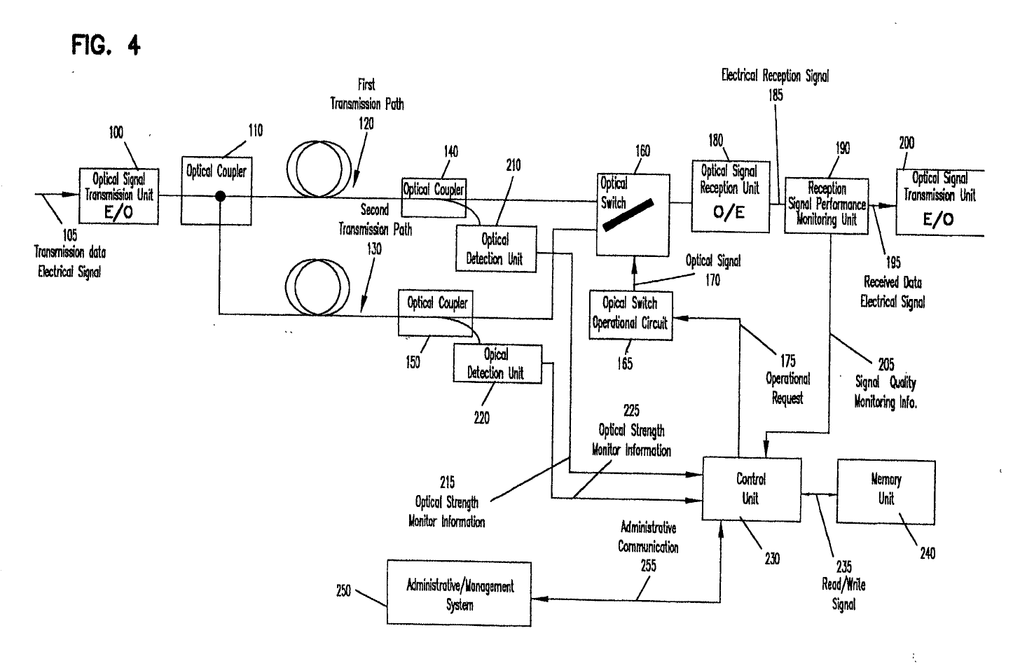

FIG. 4 is a block diagram illustrating one preferred embodiment of the basic optical 1+1 switching configuration according to the current invention. In this optical 1+1 switching configuration, at the transmission end, light is split into two paths by an optical coupler (e.g., a 3 dB coupler), and the receive signal is selected by an optical switch (e.g., a 2×1 switch).

An optical signal transmitter 100 inputs a transmission electrical data signal 105, organizes it into frames to form a transmission signal, performs electrical-to-optical signal conversion, and transmits the resulting optical signal. An optical coupler 110 receives this optical signal as its input and splits it into two signals (in a 50:50 split, for example) to output to a first transmission line 120 and a second transmission line 130. Optical couplers 140 and 150 each extract a sample (e.g. 5%) of the respective signals received via the first and second transmission lines 120 and 130, and supply the sample to optical sensors 210 and 220. The optical sensors 210 and 220 monitor the optical signal strength of the signals through the first and second transmission lines 120 and 130 and output information on the monitored optical signal strength as optical signal strength monitor data 215 and 225.

An optical switch 160 (constituting a 2×1 switch, for example) is a switch for outputting one or the other of the optical signals of the first transmission line 120 and the second transmission line 130. An optical switch driver 165 drives the switching of this optical switch 160. An optical signal receiver 180 receives the optical signal from the optical switch 160, and converts it to an electrical signal to output a reception electrical signal 185. A reception signal performance monitor 190 monitors the performance of the reception electrical signal 185 indicative of the performance of the system and outputs information on the monitored performance as signal performance monitor data 205 as well as a ‘receive electrical data signal’ 195. Signal performance monitor data 205 includes, for example, data such as LOS (loss of signal) LOF (loss of frame), AIS (alarm indication signal) and BER (bit error rate). The other output, reception electrical data signal 195, is applied to an optical signal transmitter 200. Finally, to provide the signal to a client or another system, for example, the optical signal transmitter 200 organizes the electrical data signal 195 into frames for transmission, converts it to an optical signal, and transmits it.

A controller 230 that exists generally within the apparatus, performs the system monitor and control functions based on the input optical signal strength monitor data 215 and 225, and signal performance monitor data 205.

To operate the optical switch 160, the controller 230 sends a drive request 175 to the optical switch driver 165. A memory 240 is connected to the controller 230 to provide temporary storage for data such as monitor and control results. To conduct management-related communications 255, the controller 230 is connected to a management or administrative system 250 either directly or through a controller within a higher level system not shown in the drawing. The management system 250, which exists primarily external to the apparatus, performs management-related communication 255 to monitor performance and alarms, and control the apparatus.

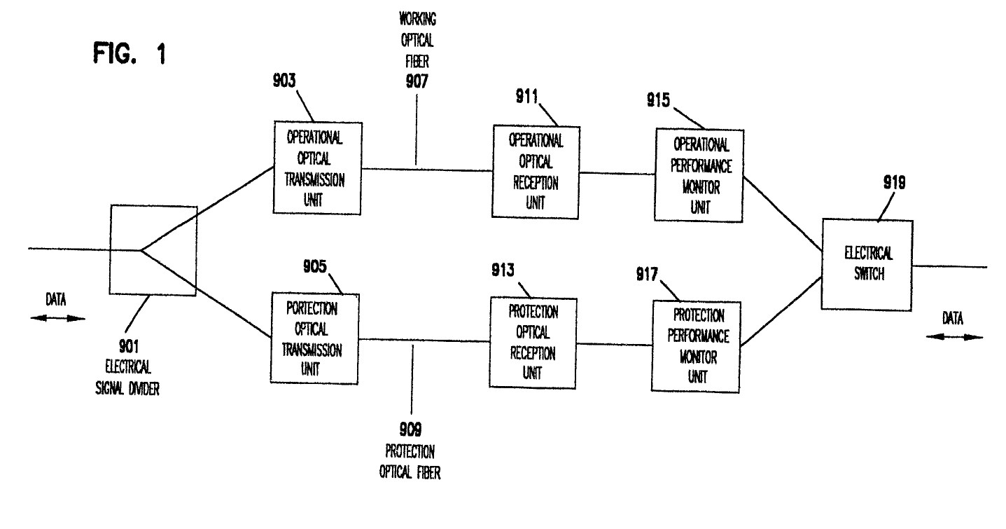

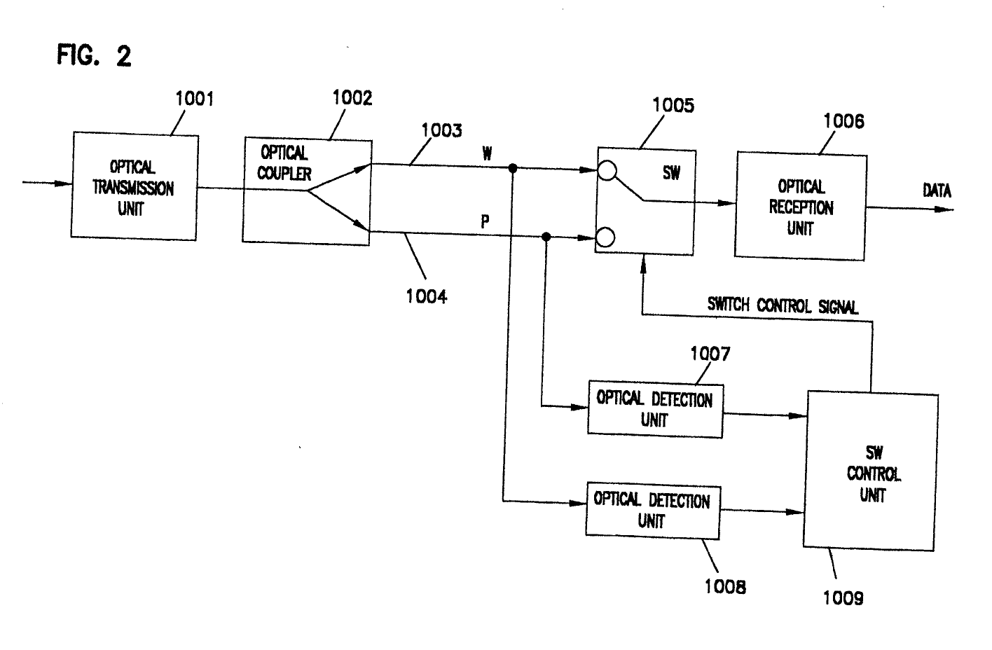

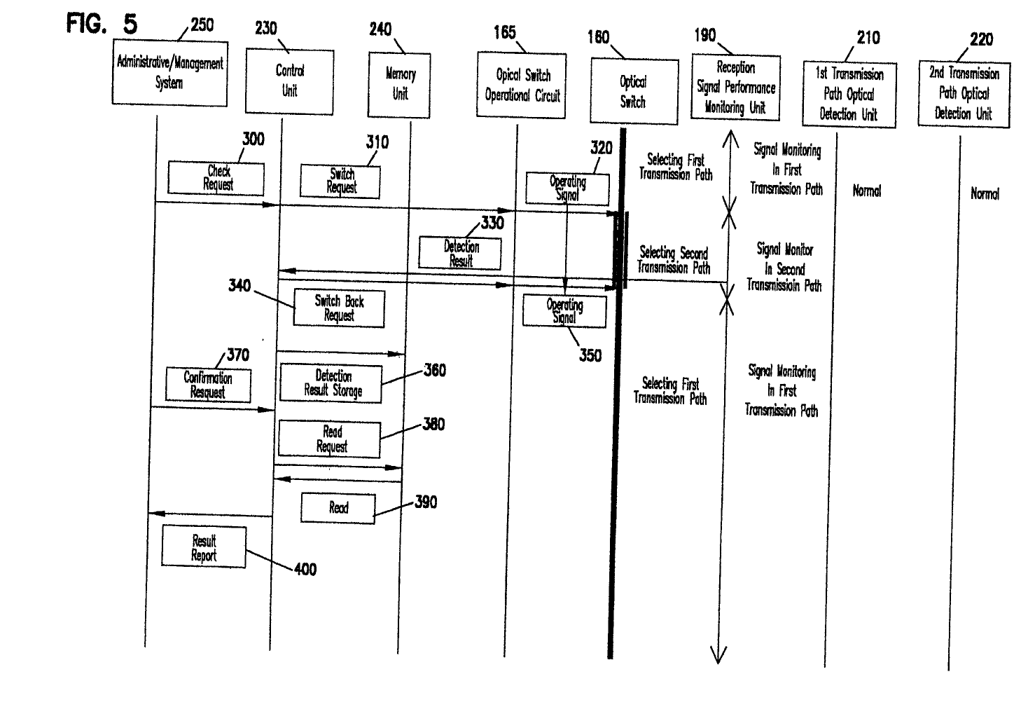

FIG. 5 shows a pre-switching check monitoring sequence for switching between the working and protection circuits. In FIG. 2, the management system 250, the controller 230, the memory 240, the optical switch driver 165, the optical switch 160, the reception signal performance monitor 190, the first transmission line optical sensor 210, and the second transmission line optical sensor 220 of FIG. 2 are all components of the basic configuration as shown in FIG. 1. In this check monitoring sequence, before switching over to the protection circuit in response to a circuit trouble or performing routine maintenance, a check request command is issued. This command results in the protection circuit being monitored for a given period of time prior to switching so as to improve the maintenance performance of the system.

First, the check sequence will be described for the case in which the first and second transmission lines are both normal or operational. The state of the system is as follows: the first and second transmission line optical sensors 210 and 220 sense that both transmission lines are normal. The first transmission line 120 is currently selected by the optical switch 160, and the reception signal performance monitor 190 is performance-monitoring the reception electrical signal 195 from the first transmission line 120.

The management or system 250 sends a check request signal 300 to the controller 230. The timing of the check request signal 300 is set, as appropriate, to be periodical or at specific times in advance. The check request 300 is alternatively activated when other equipment fails or loses power. When the controller 230 receives the check request 300, it sends a switch request 310 to the optical switch driver 165, which responds by sending a drive signal 320 to the optical switch 160.

Based on the drive signal 320, the optical switch 160 switches over from the first transmission line 120 to the second transmission line 130. As a result, the receive signal performance monitor 190 is switched to monitor the performance of the second transmission line 130 from the first transmission line 120. In order to avoid any effect on transmission, the switching to the second transmission line 130 to monitor normal performance is timed to occur, for example, when no data is being transmitted over the first transmission line 120. Alternatively the monitoring time is made brief in order to minimize any such effects.

For the second transmission line 130, the receive signal performance monitor 190 sends a sensing result 330 to the controller 230. Upon receiving the sensing result 330, the controller 230 sends a switch-back request 340 to the optical switch driver 165, which responds by sending a drive signal 350 to the optical switch 160. Based on the drive signal 350, the optical switch 160 switches from the second transmission line 130 to the first transmission line 120. As a result, the receive signal performance monitor 190 is switched from monitoring the performance of the second transmission line 130 to monitoring the performance of the first transmission line 120.

The controller 230 performs a sensing result save operation 360 to save the result in the memory 240 based on information from the receive signal performance monitor 190, the first transmission line optical sensor 210, and the second transmission line optical sensor 220. In addition, the management system 250 sends a confirmation request 370 to the controller 230. Upon receiving the confirmation request 370, the controller 230 sends a read request 380 to the memory 240. The controller 230 performs a sensing results read operation 390 and sends a results report 400 to the management system 250. The management system 250 saves the results report 400 in an appropriate memory device. The sensing result save operation in the memory 360 and the result report operation 400 generated by the management system 250 are repeated as often as appropriate, and at the appropriate times.

When a trouble occurs in the working circuit (the first transmission line 120), the controller 230 performs the above check operation to check the second transmission line 130 before switching that line to the working circuit. Thus, the optical switch 160 is operated to switch to the second transmission line 130 as the working circuit only after it is determined that the operational state in the second transmission line 130 is normal. Thus, this feature positioning assures that transmission will be maintained. On the other hand, if the controller 230 receives a detection result 330 indicating that the second transmission line 130 is not normal, the optical switch 160 indicates an alarm without switching the second transmission line 130.

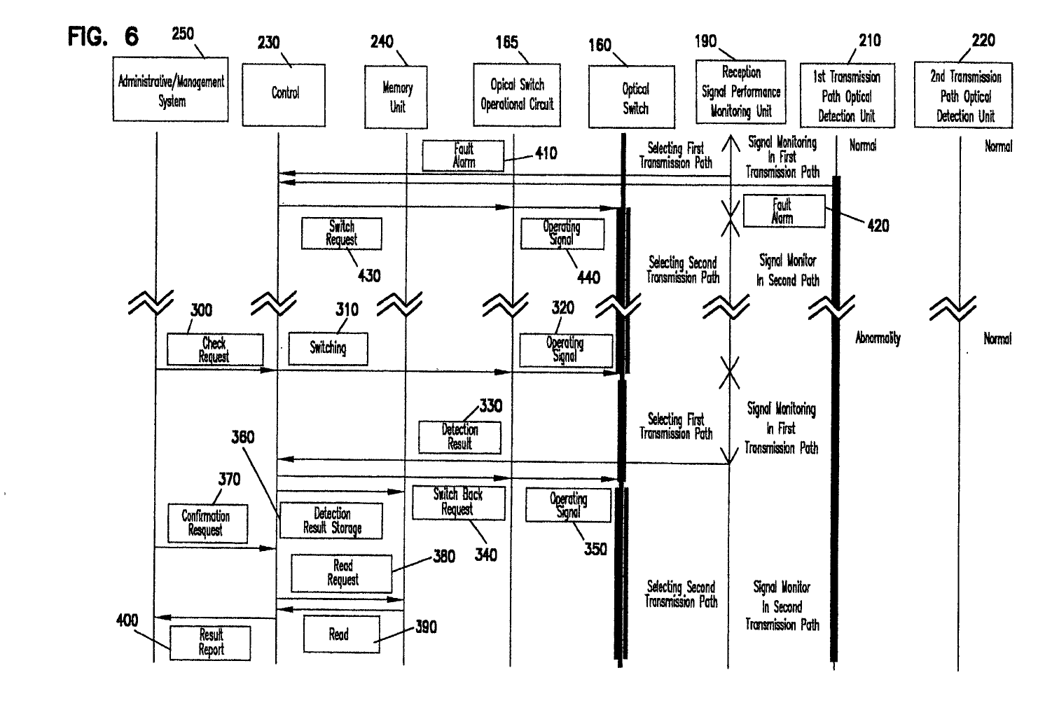

FIG. 6 shows a post-switching check sequence for the switching operation between the working and protection circuits. In this check sequence, a check request command 300 is issued after the switch between the working and protection circuits. This leads to monitor the protection circuit for a given period of time after the switching operation to improve the maintenance performance of the system.

The operations will be described for the case wherein a fault has occurred in the first transmission line 120. When the fault occurs in the first transmission line 120, the abnormal state is detected by the first transmission line optical sensor 210. The first transmission line 120 is currently selected by the optical switch 160, and the receive signal performance monitor 190 monitors the performance of the first transmission line 120. The receive signal performance monitor 190 and the first transmission line optical sensor 210 respectively send fault alarms 410 and 420 to the controller 230. When it receives the fault alarms 410 and 420, the controller 230 sends a switch request 430 to the switch driver 165. When the optical switch driver 165 receives the switch request 430, it sends a drive signal 440 to the optical switch 160. Based on the drive signal 440, the optical switch 160 switches from the first transmission line 120 to the second transmission line 130, and data transmission is maintained with the second transmission line 130 as the working circuit. As a result, the receive signal performance monitor 190 is switched from the first transmission line 120 to monitor the performance of the second transmission line 130.

The management system 250 sends a check request 300 to the controller 230 in accordance at a prescribed timing. Here, the prescribed timing dictates for example, that the check request be sent after a specific time has elapsed following the switching of the optical switch 160, periodically at specific intervals, or based on the number of requests. When the controller 230 receives the check request 300, it sends a switch request 310 to the optical switch driver 165. When the optical switch driver 165 receives the switch request 310, it sends a drive signal 320 to the optical switch 160. Based on the drive signal 320, the optical switch 160 switches from the second transmission line 130 to the first transmission line 120. As a result, the receive signal performance monitor 190 is switched from monitoring the performance of the second transmission line 130 to monitoring the performance of the first transmission line 120. In order to avoid only effect on transmission, this switching to the first transmission line 120 to monitor normal performance is timed, for example, when no data is being transmitted over the second transmission line 130, or the monitoring time is brief in order to minimize any such effects.

The receive signal performance monitor 190 sends the first transmission line 120 sensing result 330 to the controller 230. This is done to determine whether the first transmission line 120 has recovered from the fault condition. Upon receiving the sensing result 330 from the receive signal performance monitor 190, the controller 230 sends a switch-back request 340 to the optical switch driver 165, which responds by sending a drive signal 350 to the optical switch 160. Based on the drive signal 350, the optical switch 160 switches from the first transmission line 120 to the second transmission line 130. Accordingly, the receive signal performance monitor 190 is switched from monitoring the performance of the first transmission line 120 to monitoring the performance of the second transmission line 130.

The controller 230 performs a sensing result save operation 360 in the memory 240 based on information from the receive signal performance monitor 190, the first transmission line optical sensor 210, and the second transmission line optical sensor 220. In addition, the management system 250 sends a confirmation request 370 to the controller 230. Upon receiving the confirmation request 370, the controller 230 sends a read request 380 to the memory 240. The controller 230 performs a read operation 390 to read the sensing results from the memory 240, and sends a results report 400 to the management system 250. The management system 250 saves the results report 400 in an appropriate memory device.

Through the above operation, after switching to the second transmission line 130 as the working circuit, due to a problem in the first transmission line 120, if it is determined from the first transmission line 120 sensing result 330 that the line has not returned to its former operational state, the controller 230 leaves the system as-is and the second transmission line 130 remains selected as the working line. On the other hand, if the controller 230 receives from the receive signal performance monitor 190, the sensing result 330 indicating that the first transmission line 120 has been restored to the normal operation state, the first transmission line 120 is re-selected by the optical switch 160.

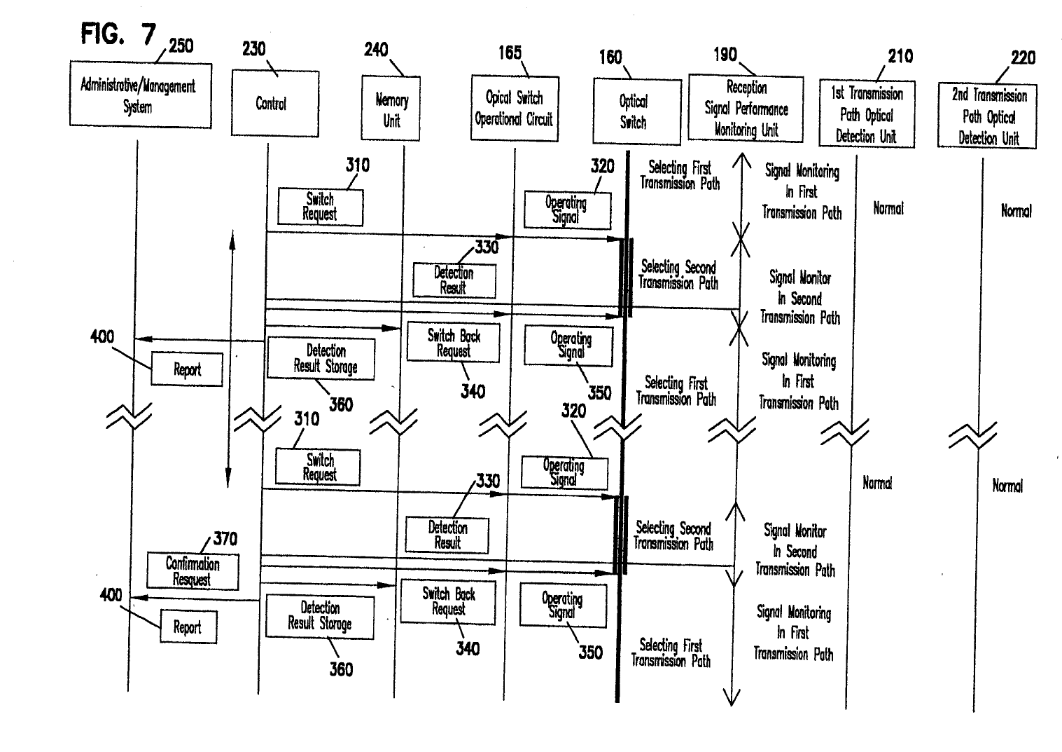

FIG. 7 shows a check sequence for periodic monitoring of a protection circuit. In this sequence, switching request commands are periodically issued to monitor the protection circuit for a prescribed amount of time so as to improve the maintenance performance of the system.

An exemplary automatic check operation is performed when both the first and second transmission lines 120 and 130 are operating normally. The first and second transmission line optical sensors 210 and 220 detect that both transmission lines are operating normally. The first transmission line 120 is currently selected by the optical switch 160, and the receive signal performance monitor 190 monitors the performance of the electrical receive signal 195 from the first transmission line 120.

When a check is due for the operational state of the second transmission line 130 as determined by system timing, the controller 230 sends a switching request 310 to the optical switch driver 165, which sends a drive signal 320 to the optical switch 160. Based on the drive signal 320, the optical switch 160 switches from the first transmission line 120 to the second transmission line 130. The optical switch 160 also switches the receive signal performance monitor 190 from monitoring the first transmission line 120 to monitoring the second transmission line 130. The receive signal performance monitor 190 sends a sensing result 330 for the second transmission line 130 to the controller 230.

When the controller 230 receives the sensing result 330, it sends a switch-back request 340 to the optical switch driver 165. Upon receiving the switch-back request 340, the optical switch driver 165 sends a drive signal 350 to the optical switch 160. Based on the drive signal 350, the optical switch 160 switches from the second transmission line 130 to the first transmission line 120. The optical switch 160 also switches the reception signal performance monitor 190 from monitoring the performance of the second transmission line 130 to monitoring the performance of the first transmission line 120. In order to avoid any effect on transmission, the switching to the second transmission line 130 to monitor for normal performance is timed, for example, when no data is being transmitted over the first transmission line 120, or the monitoring time is brief in order to minimize any such effects.

The controller 230 performs a sensing result data save operation 360 to the memory 240 based on information from the receive signal performance monitor 190, the first transmission line optical sensor 210, and the second transmission line optical sensor 220. The controller 230 also sends a report 400 to the management system 250 to store in a memory device.

When it is time for another check on the operational status of the second transmission line 130, the controller 230 sends a switching request 310 to the optical switch driver 165, and the operational status of the second transmission line 130 is checked by the same process as described above. Appropriate timing of these checks is determined at a predetermined period or the checks are triggered by predetermined events such as failures in other systems or power failures. For the periodic checks, the above pre- and post-switching checks are combined.

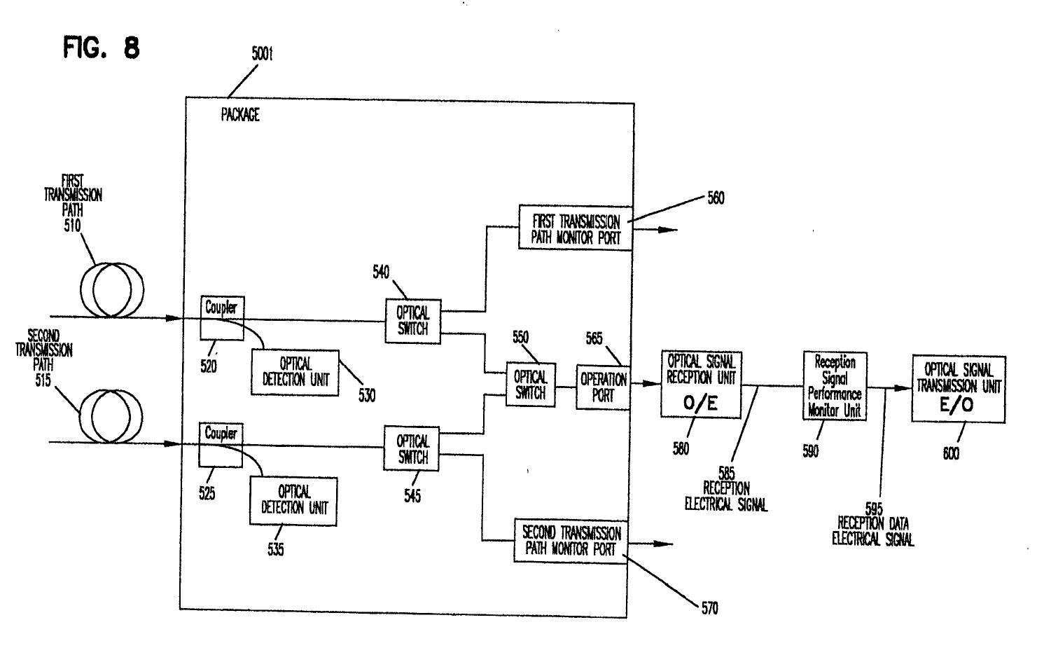

FIG. 8 is a block diagram illustrating a system that includes a package with first exemplary monitor ports.

A package 5001 comprises optical couplers 520 and 525, optical sensors 530 and 535, optical switches 540, 545, and 550, a first transmission line monitor port 560, a second transmission line monitor port 570, and a working circuit port 565. The package 5001 is alternatively configured without certain of these constituent elements within the scope of the invention.

The first and second transmission lines 510 and 515, the optical couplers 520 and 525, the optical sensors 530 and 535, the optical switch 550, the optical signal receiver 580, the receive signal performance monitor 590, and the optical signal transmitter 600 are equivalent respectively to the first and second transmission lines 120 and 130, the optical couplers 140 and 150, the optical sensors 210 and 220, the optical switch 160, the optical signal receiver 180, the receive signal performance monitor 190, and the optical signal transmitter 200 of the basic configuration as shown in FIG. 1.

The working circuit port 565 is an output port for the signal in the working circuit. The first transmission line monitor port 560 outputs a signal in the first transmission line 510 under switching control of the optical switch 540 when that signal is not used in the working circuit. The second transmission line monitor port 570 outputs a signal in the second transmission line 515 under switching control of the optical switch 545 when that signal is not used in the working circuit. If necessary, a drive circuit is provided for each of these optical switches (540 and 545) to control switching by the controller 230 in the above basic configuration.

The first exemplary monitor port configuration improves the maintenance performance by providing monitor ports for the first and second transmission lines (510 and 515) so as to monitor the protection circuit output after a switch-over from the working circuit to the protection circuit.

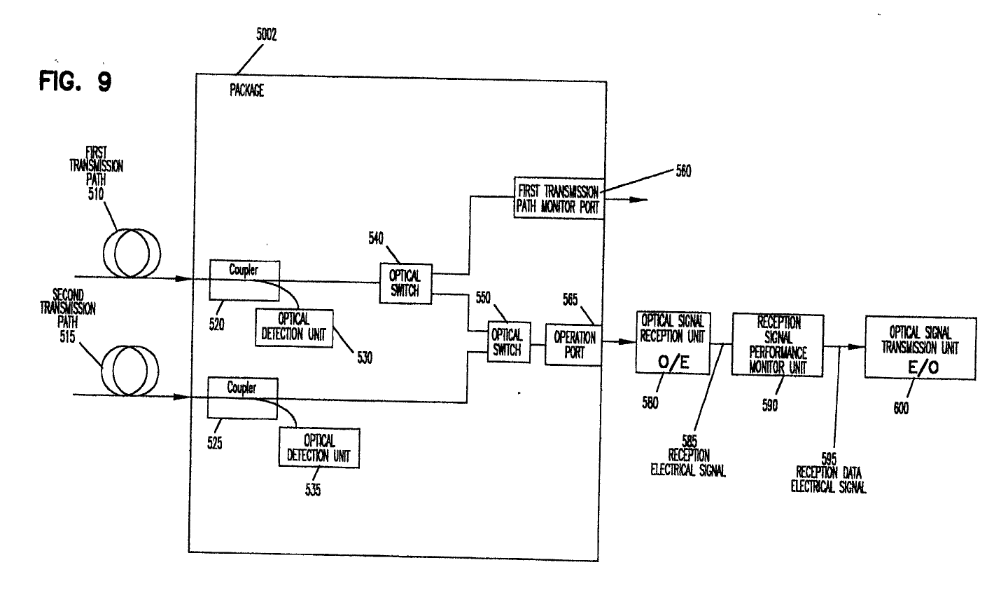

FIG. 9 is a block diagram illustrating a system that includes a package with second exemplary monitor ports.

A package 5002 comprises optical couplers 520 and 525, optical sensors 530 and 535, optical switches 540 and 550, a first transmission line monitor port 560, and a working circuit port 565. The package 5002 are alternatively configured without certain of these constituent elements within the scope of the invention. Other configurations are the same as in the above first exemplary monitor port configuration.

The second exemplary monitor port configuration improves maintenance performance by providing a port only for the first transmission line 510. This arrangement enables to monitor the protection circuit output after a switch-over from the working circuit to the protection circuit.

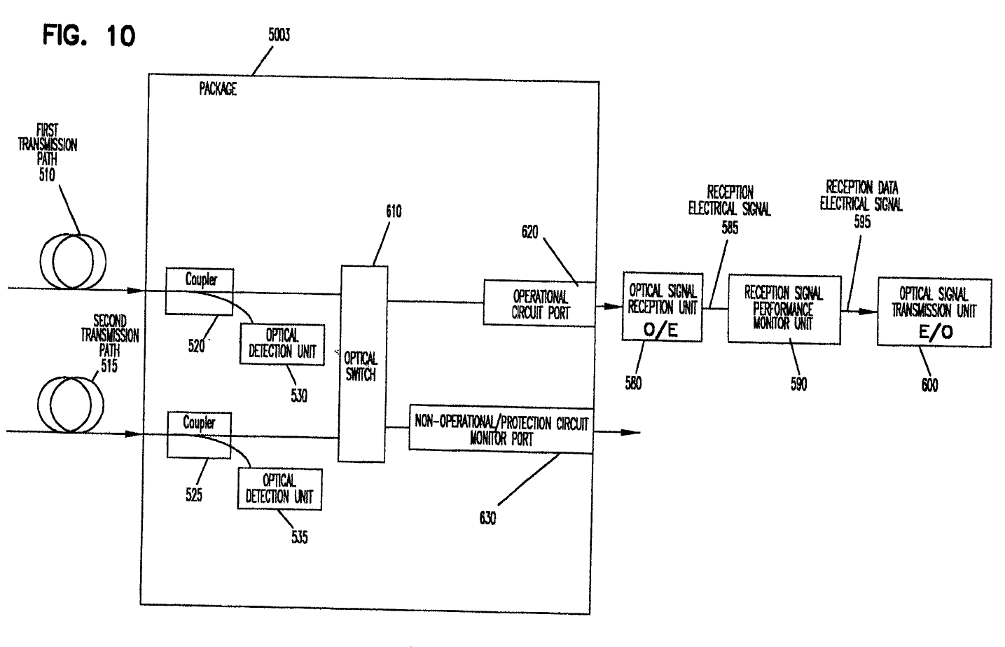

FIG. 10 is a block diagram illustrating a system that includes a third exemplary package with monitor ports.

A package 5003 comprises optical couplers 520 and 525, optical sensors 530 and 535, an optical switch 610, a working circuit port 620, and a protection circuit monitor port 630. The package 5003 are alternatively configured without certain of these constituent elements within the scope of the invention. Other configurations are the same as in the above first exemplary monitor port configuration.

The working circuit port 620 is an output port for the signal used in the working circuit. The protection circuit monitor port 630 is an output port for the signal used in the protection circuit. The optical switch 610 such as a 2×2 switch is able to select or cross-switch the signals of the first transmission line 510 and the second transmission line 515 to output to either the working circuit port 620 or the protection circuit monitor port 630. In a first state, this optical switch 610 applies a certain signal that has passed through the first transmission line 510 to the working circuit port 620 while it applies certain another signal that has passed through the second transmission line 515 to the protection circuit monitor port 630. Conversely, when the optical switch 610 is switched to a second state, the optical switch 610 applies the signal that has passed through the first transmission 510 to the protection circuit monitor port 630 while the optical switch applies the signal that has passed through the second transmission line 515 to the working circuit port 620. Thus the optical switch 610 performs substantially the same function of optical switch 160 in the above basic configuration as well as a monitor switch function. If necessary, a drive circuit is provided for the optical switch 610 and its switching operation is controlled by the controller 230 of the above basic configuration.

The third exemplary monitor port configuration is employed to improve maintenance performance by a protection circuit monitor port 630 which monitor an output signal from a new protection circuit following its switch-over from the working circuit to the protection circuit regardless of whether the first transmission line 510 or the second transmission line 515 is used.

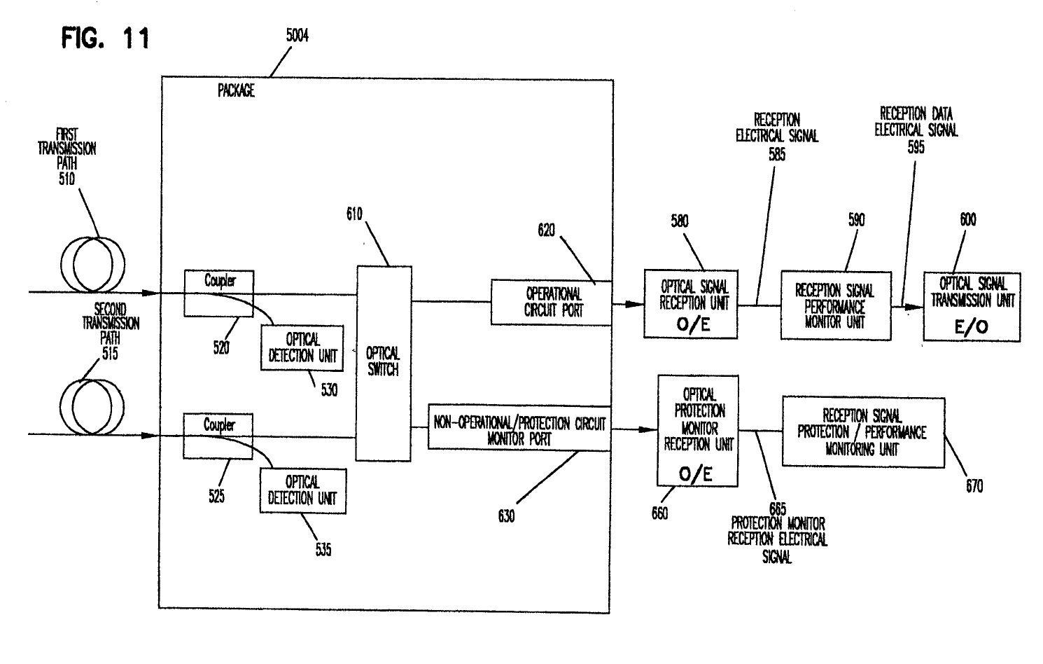

FIG. 11 shows a modified version of the third exemplary monitor port configuration.

A monitor optical signal receiver 660 and a monitor reception signal performance monitor 670 for the protection circuit monitor port 630 are included in the third exemplary configuration. This improves the maintenance performance by monitoring the quality of the protection circuit signal. This added portion is optionally used along with other optical 1+1 protection circuit switching schemes.

The protection circuit monitor optical signal receiver 660 receives the protection circuit optical signal and performs O/E conversion to convert it to an electrical signal, which is outputted as a protection circuit monitor electrical receive signal 665. The protection receive signal performance monitor 670 monitors the performance of signals received over the protection circuit. For SONET/SDH, for example, this configuration would provide the same monitoring capability as that provided by the receive signal performance monitor 190 of FIG. 1.

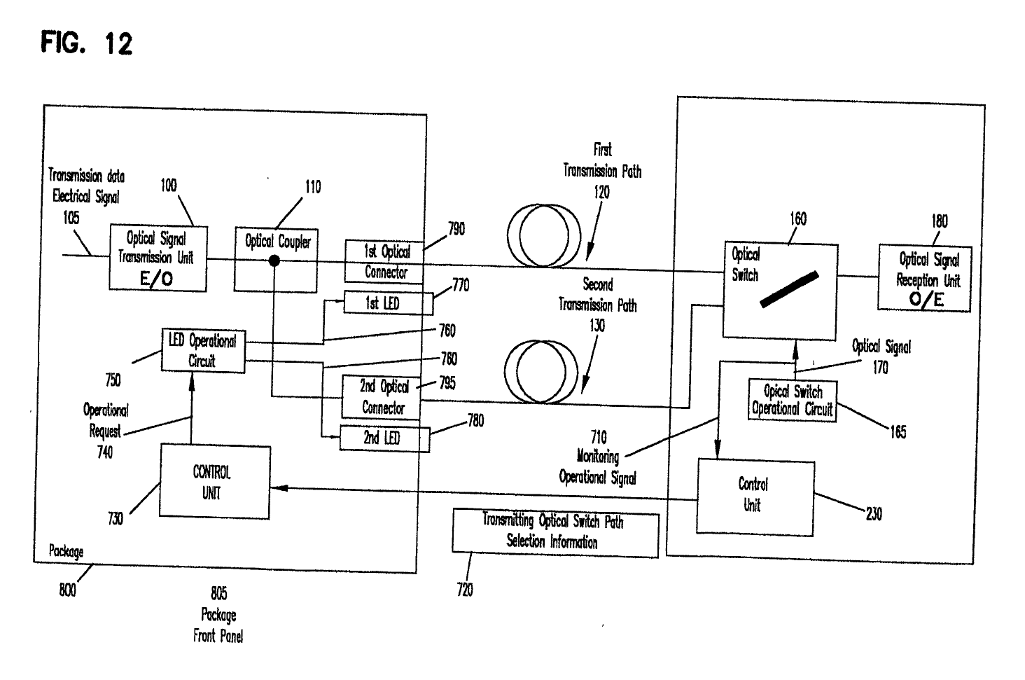

FIG. 12 is a block diagram illustrating a system having a function that indicates the path selection status at the transmission end. The isolation and repair of circuit faults are sometimes performed by looking for a fault location from upstream via transmitted signal. To maintain transmission during this process, it is important to avoid the removal of optical connectors associated with the working circuit. Accordingly, in this working example, the path selection status of the downstream optical switch is indicated at the upstream or the transmission end of the circuit so as to keep maintenance personnel at the upstream end informed as to which line is currently the working circuit. This improves maintenance performance by minimizing the chance that the maintenance personnel might inadvertently turn off switches or remove connectors related to the working circuit equipment/transmission line.

In this preferred embodiment, the above basic configuration is expanded to have the controller 230 send optical switch path selection status information 720 upstream to the transmission end. Through the optical switch path selection status information 720, the downstream status of path selection is provided from the downstream end to the upstream end. The circuit for transmitting this information uses any appropriate method such as an in-signal overhead signal or the optical supervisory channel in a wavelength-division multiplex system. A transmit-end controller 730 receives the optical switch path selection status information 720 from the downstream end of the circuit and outputs a drive request 740. Based on the drive request 740, an LED driver 750 turns on either the ‘first transmission line selected’ LED 770 or the ‘second transmission line selected’ LED 780 to indicate either the first transmission line 120 or the second transmission line 130 as the working circuit. The ‘first transmission line selected’ LED 770 is turned on, for example, if the transmission path selected downstream is the first transmission line 120, and the ‘second transmission line selected’ LED 780 is turned on if the transmission path selected downstream is the second transmission line 130.

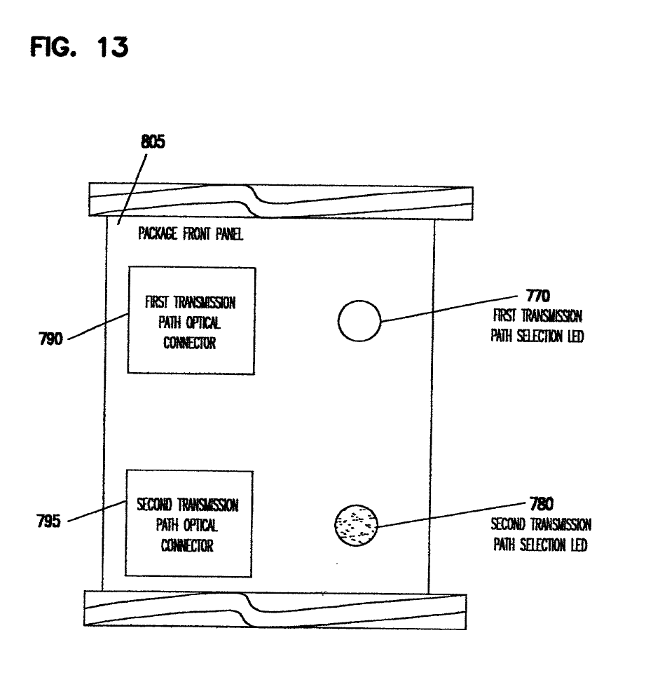

FIG. 13 shows the configuration of a transmit-end package front panel. Mounted in the transmit-end package front panel include a ‘first transmission line selected’ LED 770, a ‘second transmission line selected’ LED 780, a first transmission path optical connector 790, and a second transmission path optical connector 795.

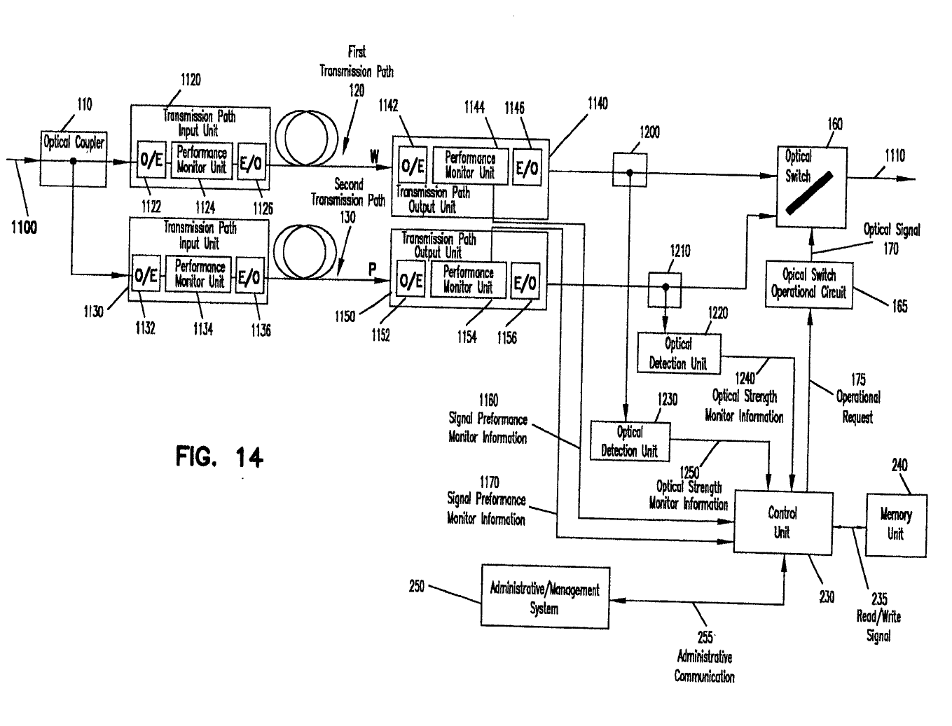

FIG. 14 is a block diagram illustrating a switching scheme for 1+1 optical transmission lines, in which switching is based on the performance monitor information obtained from a transmission line output device. In the optical 1+1 switching scheme, the transmission end optical signal is split by a coupler (e.g., a 3 dB coupler), and the receive signal is selected by an optical switch (e.g. a 2×1 switch).

An optical coupler 110 splits its optical signal 1100 input into two output signals (in a 50:50 split, for example) to a first transmission line input unit 1120 and a second transmission line input unit 1130. In the first and second transmission line input devices 1120 and 1130, optical signal receivers 1122 and 1132 receive the two input signals monitor-and-process units 1124 and 1134 monitor performance of the optical signals and convert formats. Optical signal transmitters 1126 and 1136 perform wavelength conversion and output the resulting signals to the first and second transmission lines 120 and 130. In the first and second transmission line output units 1140 and 1150, optical signal receivers 1142 and 1152 receive the optical signals transmitted over the first and second transmission lines 120 and 130. Monitor-and-process units 1144 and 1154 monitor performance in the optical signals and conversion of formats. Optical transmitters 1146 and 1156 perform E/O conversion and output optical signals. Monitor-and-process units 1144 and 1154 monitor the performance in the received signals, and output the results of the monitoring as ‘signal performance monitor data’ 1160 and 1170 for example. Signal performance monitor data 1160 and 1170 is the same monitor data as the signal performance monitor data 205 of FIG. 1. The optical couplers 1200 and 1210 respectively extract small samples such as 5% of the output signals from the first and second transmission line output units 1140 and 1150. Optical sensors 1220 and 1230 monitor the signal strength of the optical signals that have been outputted by the first and second transmission line output units 1140 and 1150. The optical sensors 1220 and 1230 output their sensing results as ‘optical signal strength monitor data’ 1240 and 1250.

An optical switch 160 is a switch for selecting one or the other of the optical signals that have been outputted from the first and second transmission line output units 1140 and 1150, and the selected signal is outputted as an ‘optical receive signal’ 1110. For example, the optical switch 160 is a 2×1 switch. An optical switch driver 165 drives the switching of the optical switch 160.

A controller 230 primarily exists within the apparatus performs system to monitor and control functions based on signal performance monitor data 1160 and 1170 in addition to the optical signal strength monitor data 1240 and 1250. To operate the optical switch 160, the controller 230 sends a drive request 175 to the optical switch driver 165. A memory 240 is connected to the controller 230 to provide temporary storage for data such as monitor and control results. To conduct management-related communications 255, the controller 230 is connected either directly or indirectly to a management system 250 for exchanging management and control information therebetween. The indirect connection is not shown in the figure. The management system 250, which exists primarily external to the apparatus, performs management-related communication 255 to monitor performance and alarms as well as control the apparatus.

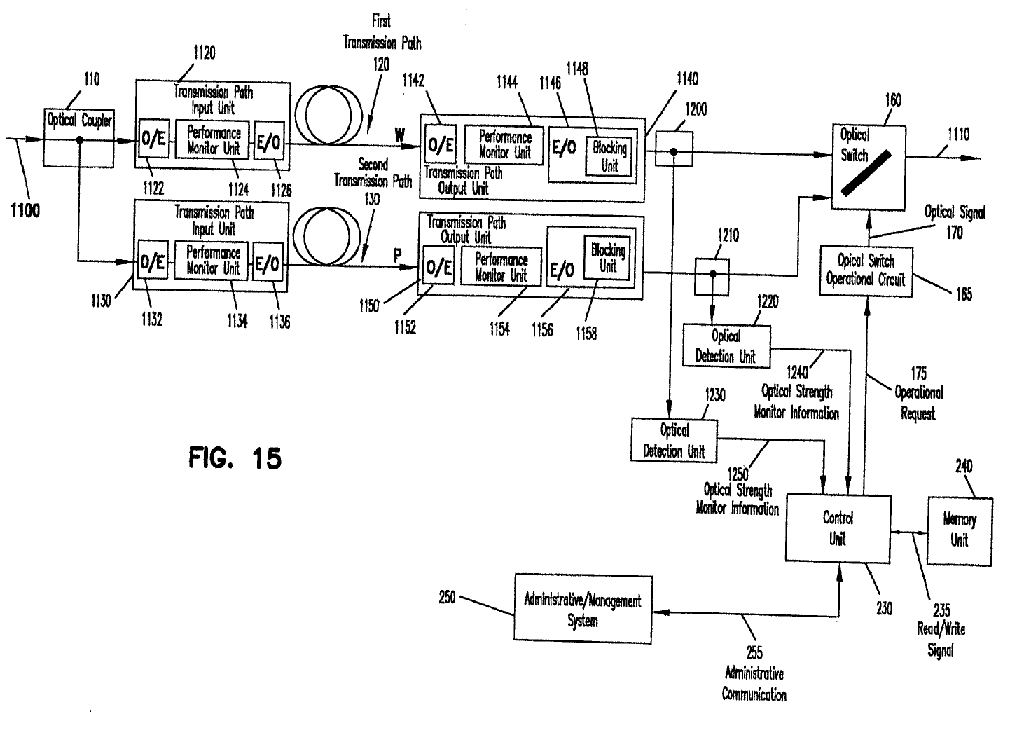

FIG. 15 is a block diagram illustrating a basic 1+1 optical switching configuration in which switching is performed by blocking the optical output signal of a transmission line output unit. The configuration of FIG. 15 does not use the signal performance monitor data 1160 and 1170 of FIG. 14, in which the performance monitoring results are sent. Therefore, blocking devices 1148 and 1158 are located in the first and second transmission line output units 1140 and 1150 to block the optical output signals. Reception signal performance monitoring is performed in monitor-and-process units 1144 and 1154, and the performance monitoring results are sent to blocking devices 1148 and 1158. As for the method of transmitting these results, any appropriate method includes separate lines in the transmission line output units 1140 and 1150 and empty areas of the signal frame. Based on the transmitted monitor results, the blocking devices 1148 and 1158 block the optical output of the first transmission line 120 or second transmission line 130 when the performance of either line is degraded. Optical couplers 1200 and 1210 extract small samples such as 5% of the optical signals from the first and second transmission line output units 1140 and 1150. Optical sensors 1220 and 1230 monitor the optical signal strength of output optical signals from the first and second transmission line output units 1140 and 1150 and output ‘optical signal strength monitor data’ 1240 and 1250, which contain information on the monitored optical signal strength. When a transmission line is determined to be faulty as a result of performance monitoring by monitor-and-process units 1144 and 1154 as described above, the signal of that transmission line will be blocked by one of the blocking devices 1148 and 1158. This will result in either of the lines to be faulty or low optical signal strength based upon by the corresponding optical sensor 1220 or 1230. A controller 230 is generally located within the apparatus and performs system monitor and control functions based on optical signal strength monitor data 1240 and 1250. Other than the above, this configuration is the same as that of FIG. 14.

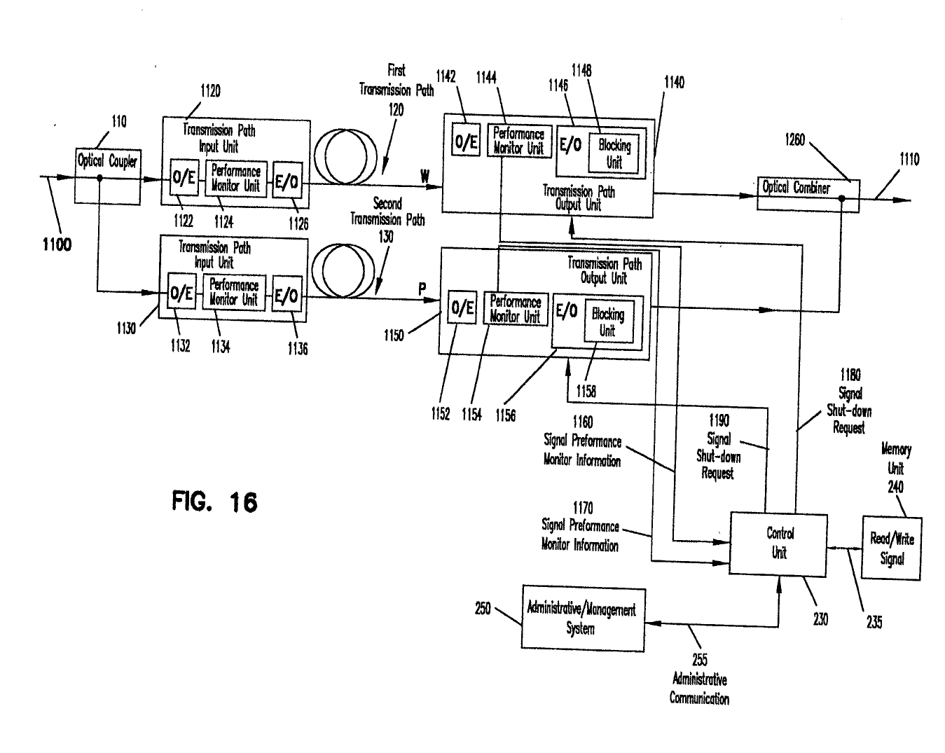

FIG. 16 is a block diagram illustrating a basic optical 1+1 switching configuration with no optical switch. In this optical 1+1 switching scheme, the optical signal at the transmission end is split by a coupler such as a 3 dB coupler, and the output optical reception signal is combined by another optical coupler that will be referred to hereinafter as an ‘optical combiner’. To select a signal from the two transmission lines as the optical receive signal 1110, the optical signal to be input to the ‘optical combiner’ 1260 is selected by blocking devices 1148 and 1158 in the first and second transmission line output units 1140 and 1150 for blocking the optical output signals.

An optical coupler 110 splits its optical signal 1100 input into two signals in such a manner as a 50:50 split to a first transmission line input unit 1120 and a second transmission line input unit 1130. In the first and second transmission line input units 1120 and 1130, optical signal receivers 1122 and 1132 receive the two input signals; monitor-and-process units 1124 and 1134 monitor performance of the optical signals and convert formats. Optical signal transmitters 1126 and 1136 perform wavelength conversion, and output the resulting signals to the first and second transmission lines 120 and 130. In the first and second transmission line output units 1140 and 1150, optical signal receivers 1142 and 1152 receive the optical signals transmitted over the first and second transmission lines 120 and 130; monitor-and-process units 1144 and 1154 monitor performance of the optical signals and convert formats. Optical transmitters 1146 and 1156 perform signal wavelength conversion and output the optical signals. Monitor-and-process units 1144 and 1154 monitor performance of the received signals, and output the results as ‘signal performance monitor data’ 1160 and 1170. For example, signal performance monitor data 1160 and 1170 are the same as the signal performance monitor data 205 of FIG. 1. The optical combiner 1260 combines the optical signals output from the first and second transmission line output units 1140 and 1150 and outputs the optical reception signal 1110. For example, the combiner is made using an optical coupler.

A controller 230 is generally located in the apparatus and performs the system monitor and control functions based on signal performance monitor data 1160 and 1170. To switch the input signals to the optical combiner 1260, the controller 230 sends signal blocking requests 1180 and 1190 to the first and second transmission line output units 1140 and 1150. A memory 240 is connected to the controller 230 to provide temporary storage for data such as monitor and control results.

To conduct management-related communications 255, the controller 230 is connected either directly or indirectly to a management system 250, for exchanging monitor and control information therebetween. The indirect connection is not shown in the figure. The management system 250 is generally located external to the apparatus. The management system 250 performs equipment and management-related communication 255 to monitor performance and alarms as well as to control the apparatus.

As described above, according to the present invention, it is possible to monitor the signal quality, etc., of the protection circuit even while the working circuit is operating. This facilitates maintenance of the protection circuit equipment.

What is claimed is:

1. A method of monitoring optical signal in a plurality of optical lines for selecting one of the optical lines, comprising:
a) providing at least a first optical line and a second optical line;
b) initializing the first optical line and the second optical line respectively as an operational line and a protection line;
c) determining optical strength at least in the operational line;
d) determining performance at least in the operational line; and
e) designating the first optical line and the second optical line respectively as the protection line and the operational line based upon any combination of the optical strength and the performance of the first optical line and the second optical line.

2. The method of monitoring optical signal in a plurality of optical lines for selecting one of the optical lines according to claim 1 wherein the performance is determined in both the first optical line and the second optical line.

3. The method of monitoring optical signal in a plurality of optical lines for selecting one of the optical lines according to claim 1 wherein the optical strength is determined in both the first optical line and the second optical line.

4. The method of monitoring optical signal in a plurality of optical lines for selecting one of the optical lines according to claim 1 wherein the performance is determined in the protection line before said step e).

5. The method of monitoring optical signal in a plurality of optical lines for selecting one of the optical lines according to claim 1 wherein the optical strength is determined in the protection line before said step e).

6. The method of monitoring optical signal in a plurality of optical lines for selecting one of the optical lines according to claim 1 wherein the performance is determined in the operational line after said step e).

7. The method of monitoring optical signal in a plurality of optical lines for selecting one of the optical lines according to claim 1 wherein the optical strength is determined in the operational line after said step e).

8. The method of monitoring optical signal in a plurality of optical lines for selecting one of the optical lines according to claim 1 wherein the performance is determined in the protection line after said step e).

9. The method of monitoring optical signal in a plurality of optical lines for selecting one of the optical lines according to claim 8 further comprising:
f) designating back the first optical line and the second optical line respectively as the operational line and the protection line based upon the performance of the protection line.

10. The method of monitoring optical signal in a plurality of optical lines for selecting one of the optical lines according to claim 1 wherein the optical strength is determined in the protection line after said switching.

11. The method of monitoring optical signal in a plurality of optical lines for selecting one of the optical lines according to claim 10 further comprising:
g) designating back the first optical line and the second optical line respectively as the operational line and the protection line based upon the optical strength of the protection line.

12. The method of monitoring optical signal in a plurality of optical lines for selecting one of the optical lines according to claim 1 further comprising:
h) storing data on the optical strength and the performance.

13. The method of monitoring optical signal in a plurality of optical lines for selecting one of the optical lines according to claim 12 wherein repeating said steps c) through e) in response to a request and i) reporting the stored data.

14. The method of monitoring optical signal in a plurality of optical lines for selecting one of the optical lines according to claim 1 wherein said designating is optical switching between the first optical line and the second optical line.

15. The method of monitoring optical signal in a plurality of optical lines for selecting one of the optical lines according to claim 1 wherein said designating is optical blocking one of the first optical line and the second optical line.

16. A system for monitoring optical signal in a plurality of optical lines for selecting one of the optical lines, comprising:
at least a first optical line and a second optical line;
an optical line selector for selecting one of the first optical line and the second optical line;
a first control unit connected to said optical line selector for generating a selection signal indicative of selecting the first optical signal and the second optical signal, said first control unit initializing the selection signal indicative of selecting the first optical line and the second optical line respectively as an operational line and a protection line;
an optical detector connected to at least the operational line for determining optical strength in the operational line; and
an optical performance monitor connected to at least the operational line for determining performance in the operational line, wherein said first control unit further connected to said optical detector and said optical performance monitor for generating the selection signal indicative of the first optical line and the second optical line respectively as the protection line and the operational line based upon any combination of the optical strength and the performance of the first optical line and the second optical line.

17. The system for monitoring optical signal in a plurality of optical lines for selecting one of the optical lines according to claim 16 wherein an independent one of said optical performance monitor is connected to both the first optical line and the second optical line.

18. The system for monitoring optical signal in a plurality of optical lines for selecting one of the optical lines according to claim 17 wherein an independent one of said optical detector is connected to both the first optical line and the second optical line.

19. The system for monitoring optical signal in a plurality of optical lines for selecting one of the optical lines according to claim 18 further comprising a second control unit connected to said first control unit for initiating the generation of the selection signal.

20. The system for monitoring optical signal in a plurality of optical lines for selecting one of the optical lines according to claim 19 wherein said first control unit in response to said second control unit generates the selection signal indicative of the first optical line and the second optical line respectively as the protection line and the operational line and subsequently also generates the selection signal indicative of the first optical line and the second optical line respectively as the operational line and the protection line.

21. The system for monitoring optical signal in a plurality of optical lines for selecting one of the optical lines according to claim 19 wherein said first control unit in response to said second control unit generates the selection signal indicative of the first optical line and the second optical line respectively as the protection line and the operational line.

22. The system for monitoring optical signal in a plurality of optical lines for selecting one of the optical lines according to claim 18 further comprising a memory unit for storing data on the optical strength and the performance, said first control units reading the stored data from said memory unit to send the stored data to said second control unit.

23. The system for monitoring optical signal in a plurality of optical lines for selecting one of the optical lines according to claim 16 wherein said optical line selector is an optical switch.

24. The system for monitoring optical signal in a plurality of optical lines for selecting one of the optical lines according to claim 16 wherein said optical line selector is an optical blocking device.

25. An optical line selector package for selecting one of a plurality of optical lines, comprising:
an optical line selector connected to the plurality of input optical lines at an input side as well as at least one output optical line at an output side;
an optical line performance monitor connected to the output optical line for monitoring a predetermined set of performance characteristics in the optical lines at the output side of said optical line selector, said optical line performance monitor generating a performance signal indicative of the performance characteristics;
a selector control unit connected to said optical line performance monitor to generate a selector drive signal at least based upon the performance signal, the selector drive signal being indicative of a current selection of the input optical lines; and
wherein said optical line selector further connected to said selector control unit for selecting one of the input optical lines based upon the selector drive signal.

26. The optical line selector package for selecting one of a plurality of optical lines according to claim 25 further comprising:
an optical detector connected to one of the optical lines for detecting optical strength of the optical lines, said optical detector generating an optical strength signal indicative of the optical strength, wherein said selector control unit further connected to said optical detector for generating the selector drive signal based upon both the performance signal and the optical strength signal.

27. The optical line selector package for selecting one of a plurality of optical lines according to claim 25 further comprising:
a monitor port connected to at least one of the input lines for monitoring the input lines.

28. The optical line selector package for selecting one of a plurality of optical lines according to claim 25 further comprising:
a monitor port connected to at least one of the output lines for monitoring the output lines.

29. The optical line selector package for selecting one of a plurality of optical lines according to claim 25 further comprising:
a LED unit connected to said selector control unit for indicating the current selection of the input optical lines.
